(19) United States
(12) Patent Application Publication
(10) Pub. No.: US 2008/0135107 A1
(43) Pub. Date: Jun. 12, 2008

(54) WATER TRAP APPARATUS FOR FUEL CELL VEHICLES

(76) Inventor: Young Woo Noh, Gun-si (KR)

Correspondence Address: MORGAN, LEWIS & BOCKIUS LLP (SF), One Market, Spear Street Tower, Suite 2800, San Francisco, CA, 94105, US

(21) Appl. No.: 11/845,282

(22) Filed: Aug. 27, 2007

(30) Foreign Application Priority Data
Dec. 11, 2006 (KR) 10-2006-0125338

(51) Int. Cl. F01N 7/08; F16L 53/00

(52) U.S. Cl. 137/334; 137/565.01

(57) ABSTRACT

A water trap apparatus for a fuel cell vehicle includes: an intake duct for intaking water and air to the apparatus; a water trap, coupled to a bottom of the intake duct, and in fluid communication with the intake duct, for collecting the water; and a first line in fluid communication with the water trap, for transferring the water to a blower. The apparatus may further include a second line in fluid communication with the first line. The first line may define an air intake hole, which intakes air into the first line. The water trap may have an inclined bottom face. A heater, for heating the water, may be mounted to the water trap.

### CROSS-REFERENCE TO RELATED APPLICATIONS

This application claims the benefit under 35 U.S.C. §119(a) of Korean Patent Application No. 10-2006-0125338, filed in the Korean Intellectual Property Office on Dec. 11, 2006, the entire contents of which are incorporated herein by reference.

### BACKGROUND OF THE INVENTION

(a) Field of the Invention

The present invention relates to a water trap apparatus for fuel cell vehicles. More particularly, a water trap is positioned at the bottom of an air line so that the condensate water in the air line is collected in the water trap.

(b) Background Art

A typical fuel cell system supplies gaseous fuel such as hydrogen or carbonization gas to an anode, and supplies oxygen to a cathode to generate electricity. An electrolyte is sandwiched between the anode and the cathode.

A balance of plant (BOP) of a fuel cell vehicle typically includes an air supply device, a hydrogen and water supply device, a fuel cell stack, and a controller. The controller monitors information such as moisture, temperature, and flow rate and controls the overall operation of the other components.

In a polymer electrolyte membrane fuel cell, hydrogen and oxygen electro-chemically react with each other to generate electric energy while producing water. The supplied hydrogen is separated into a hydrogen ion and an electron at a catalyst of an anode electrode. Then, the hydrogen ion is transferred to a cathode electrode through an anion-exchange membrane so that the hydrogen ion generates electric energy while receiving the supplied oxygen and electron to produce water.

If the vehicle is parked long-term in below freezing conditions, a blower freezes the condensate water drained while the vehicle is parked.

The frozen condensate water blocks flow of fluid within the exhaust pipe, which may lead to vehicle start failure.

The information disclosed in this background of the invention section is only for enhancement of understanding of the background of the invention and should not be taken as an acknowledgement or any form of suggestion that this information forms the prior art that is already known to a person skilled in the art.

### SUMMARY OF THE INVENTION

A water trap apparatus for a fuel cell vehicle includes: an intake duct for intaking water and air to the apparatus; a water trap, coupled to a bottom of the intake duct, and in fluid communication with the intake duct, for collecting the water; and a first line in fluid communication with the water trap, for transferring the water to a blower.

The apparatus may further include a second line in fluid communication with the first line. The first line may define an air intake hole, which intakes air into the first line. The water trap may have an inclined bottom face. A heater, for heating the water, may be mounted to the water trap.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates operation of a water trap apparatus for a fuel cell vehicle under ambient temperatures above freezing;

FIG. 2 illustrates operation of a water trap apparatus for a fuel cell vehicle under ambient temperatures below freezing; and

FIGS. 3 and 4 illustrate operation of a water trap apparatus for a fuel cell vehicle when the vehicle is inclined.

### DETAILED DESCRIPTION

Reference will now be made in detail to the preferred embodiment of the present invention, examples of which are illustrated in the drawings attached hereinafter, wherein like reference numerals refer to like elements throughout. Exemplary embodiments are described below so as to explain the present invention by referring to the figures.

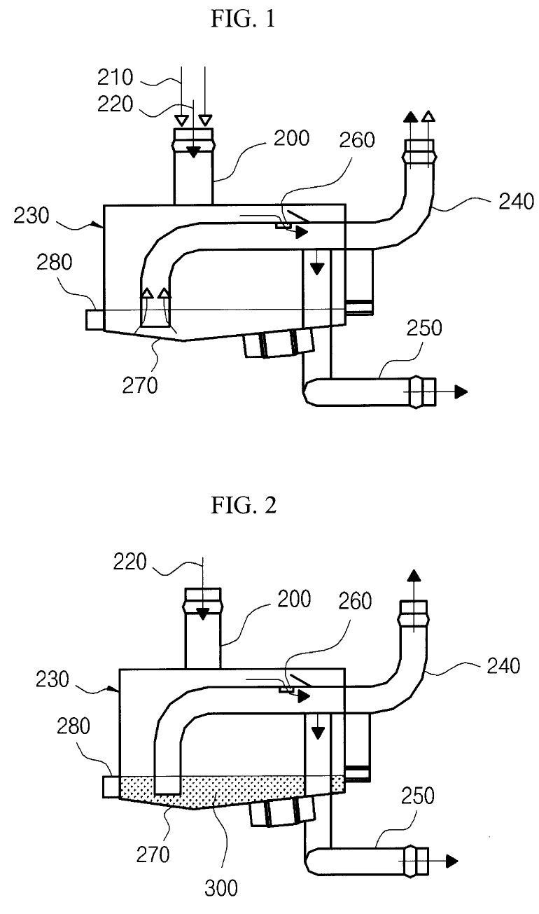

As shown in FIG. 1, when condensate water 210 is collected in a water trap 230 during driving or during parking in above freezing ambient temperatures, the condensate water collected in the water trap is transferred from a first line 240 toward a blower (not shown) by suction of the blower, and is then discharged to outside the vehicle.

Simultaneously, air 220 is introduced into the first line 240 through an air intake hole 260 on an upper portion of the first line 240 and passes through the blower. The air 220 is also supplied through an inlet port of the first line 240.

As shown in FIG. 2, when condensate water collected in the water trap is frozen during long-term parking of the vehicle in below freezing ambient temperatures, the inlet port of the first line 240 is blocked, and the air 220 is introduced into the first line 240 only through the air intake hole 260.

The frozen condensate water 300 in the water trap 230 is thawed by a heater 280 mounted to the water trap 230. Then, the thawed condensate water 210 is discharged to outside the vehicle by the same route as in FIG. 1. Upon the removal of the condensate water 210 from the water trap, the air 220 is also supplied to the system through both the inlet port of the first line 240 and the air intake hole 260.

An exemplary water trap apparatus will now be described in more detail. The intake duct 200 permits the air 220 to be introduced into the water trap 230 from a manifold. The intake duct 200 is a passageway through which the condensate water 210 is drained to the water trap 230.

The water trap 230 is coupled to the bottom of the intake duct 200, and defines a chamber to collect condensate water 210. The water trap 230 is at the bottom of a fluid pathway or loop, so that the condensate water 210 can be effectively collected.

The bottom of the water trap 230 has two inclined faces 270. The inclined faces 270 allow the level of the condensate water 210 to be higher than the inlet port of the first line 240, even if the vehicle is tilted.

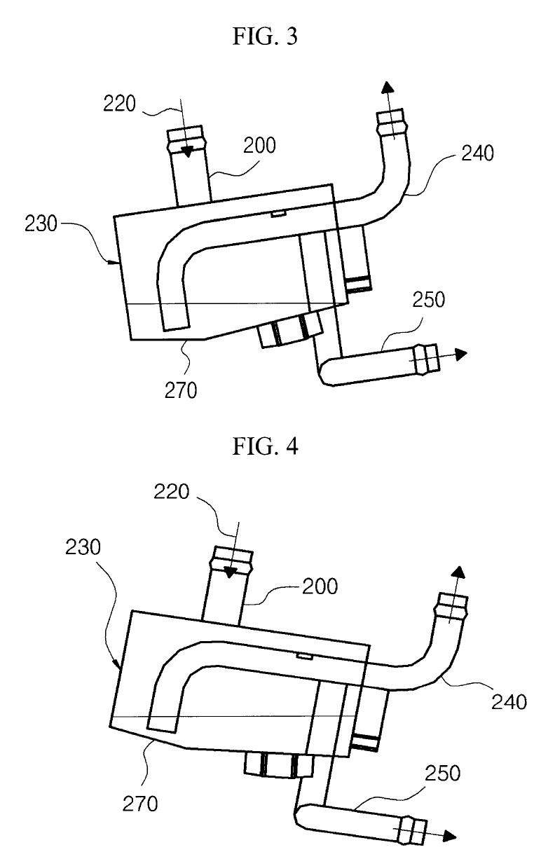

As shown in FIGS. 3 and 4, when the vehicle is tilted, the inclined faces 270 allow the condensate water 210 to enter the first line 240.

The first line 240 has a first vertical portion through which the condensate water enters, and a second vertical portion through which the condensate water is discharged to the blower. Also, the first line 240 extends transversely inside the water trap 230.

A second line 250 is coupled to one side of the first line 240 in fluid communication with the first line, so that the air 220 can be supplied to the vehicle system through a secondary blower (not shown).

In operation, first, during driving or during parking in above freezing ambient temperatures, the condensate water 210 collected in the water trap is transferred from the first line 240 toward the blower by suction of the blower, and then passes through the blower and is discharged to outside the vehicle. Simultaneously air is introduced into the first line through the air intake hole 260.

During long-term parking of the vehicle in below freezing ambient temperatures, air is introduced into the blower only through the air intake hole 260, and the frozen condensate water is thawed by the external heater 280 so that it passes through the blower by suction of the blower and is discharged to outside the vehicle.

As described above, the water trap apparatus for a fuel cell vehicle according to the present invention provides the following advantageous effects: First, the water trap is at the bottom of the fluid pathway so that the condensate water is easily collected. Second, the condensate water collected in the water trap is easily removed by the suction of the blower to thereby prevent the condensate water from being frozen. Third, even when condensate water collected in the water trap is frozen, the condensate water is easily removed through rapid thawing by the heater to thereby prevent vehicle start failure and smoothly effect the flow of air introduced into the system.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A water trap apparatus for a fuel cell vehicle, comprising:
an intake duct for intaking water and air to the water trap apparatus;
a water trap, coupled to a bottom of the intake duct, and in fluid communication with the intake duct, for collecting the water; and
a first line in fluid communication with the water trap, for transferring the water to a blower.

2. The apparatus of claim 1, further comprising a second line in fluid communication with the first line.

3. The water trap apparatus according to claim 1, wherein the first line defines an air intake hole for intaking air into the first line.

4. The water trap apparatus of claim 1, wherein the water trap comprises an inclined bottom face.

5. The water trap apparatus of claim 1, further comprising a heater mounted to the water trap, for heating the water.
